(19) United States
(12) Patent Application Publication
(10) Pub. No.: US 2005/0190858 A1
(43) Pub. Date: Sep. 1, 2005

(54) Apparatus and method for reducing peak-to-average power ratio in a CDMA communication system

(75) Inventors: Jeong-Heon Kim, Anyang-si (KR); Jpon Young Bae, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/065,066

(22) Filed: Feb. 25, 2005

(30) Foreign Application Priority Data
Feb. 27, 2004 (KR) 2004-13592

(51) Int. Cl. H04K 1/02

(52) U.S. Cl. 375/296

(57) ABSTRACT

An apparatus and a method are provided for reducing a peak-to-average power ratio of a forward link signal in a code division multiple access (CDMA) communication system. The apparatus and method include a power control object determination unit for determining a power control object by detecting a peak signal having a highest power for a predetermined period of time from among input signals including a plurality of sub-peak signals, a power correction signal generation unit for outputting at least one correction waveform in order to correct an input signal determined to be the power control object, and a power correction unit for outputting an input signal to which at least one correction waveform is applied.

### PRIORITY

This application claims the benefit under 35 U.S.C. 119(a) of an application entitled “Apparatus And Method For Reducing Peak-To-Average Power Ratio In CDMA Communication System” filed with the Korean Intellectual Property Office on Feb. 27, 2004 and assigned Serial No. 2004-13592, the entire contents of which are incorporated herein by reference.

### BACKGROUND OF THE INVENTION

1. Field of the Invention

The present invention relates to an apparatus and a method for transmitting a forward link signal in a code division multiple access (CDMA) communication system. More particularly, the present invention relates to an apparatus and a method for reducing a peak-to-average power ratio (PAPR) of a forward link signal in a CDMA communication system.

2. Description of the Related Art

In general, a code division multiple access (CDMA) signal has a relatively high peak-to-average power ratio (PAPR) because various overhead channel signals are combined with traffic signals, which are user data signals. Particularly, in a case of a frequency assignment (FA) CDMA system, the PAPR is further increased because a plurality of FA signals are added thereto.

FIG. 1 is a view illustrating a forward link signal generator in a conventional CDMA communication system using multiple carriers. A plurality of FA signals are combined and output through the forward link signal generator shown in FIG. 1.

Referring to FIG. 1, overhead channel signals derived from a pilot channel, a sync channel and a paging channel and user data signals are spread and combined in walsh spreaders 101a, 101b and 101c according to a walsh function. Signals output from the walsh spreaders 101a, 101b and 101c may undergo pulse shaping through baseband filters of pulse shaping parts 102a, 102b and 102c. In addition, multipliers 103a, 103b and 103c are provided to shift frequencies of the signals output from the pulse shaping parts 102a, 102b and 102c into predetermined frequency bands, which are allocated for each FA signal. The FA signals output from the multipliers 103a, 103b and 103c are combined in an adder 104 so that the multiple FA signal s(t) is output as a final CDMA output signal.

The overhead channel signals and user data signals are combined in the walsh spreaders 101a, 101b and 101c of each FA so that the PAPR is increased. In addition, the FA signals are combined in the adder 104 so that the PAPR is further increased. Due to such an increase of the PAPR, a power amplifier must be larger, so the manufacturing cost for the power amplifier may increase or an efficiency of the power amplifier is degraded. Thus, it is necessary to reduce the PAPR of the signal in order to reduce the manufacturing cost of the power amplifier and to improve the efficiency of the power amplifier.

Two schemes have been suggested in order to reduce the PAPR of the signal. A first scheme is to reduce the PAPR of the signal without degrading the quality of the signal. A second scheme is to reduce the PAPR of the signal by properly deforming the signal such that the quality of the signal can be maintained at a predetermined level.

The first scheme is better than the second scheme because the first scheme does not degrade the quality of the signal. However, according to the first scheme, additional information must be transmitted to a receiving terminal and the PAPR may be reduced within a small range. In addition, an apparatus for reducing the PAPR has a relatively complex structure.

A clipping scheme has been suggested in order to reduce the PAPR. According to the clipping scheme, an input signal having power exceeding a predetermined threshold power undergoes a scaling process such that the input signal has power lower than the predetermined threshold power. Such a clipping scheme allows the input signal to have power lower than the predetermined threshold power in a simplified manner, but the clipping scheme may create serious spectral emission during the clipping process. For this reason, the signal must be filtered after the clipping process in order to prevent the spectral emission. However, such a filtering process may increase the PAPR of the signal.

As the threshold power of the signal is lowered, the number of power samples of the input signal requiring power correction is increased. In addition, as the number of the power samples requiring the power correction increases, the distortion of the signal becomes larger. In order to reduce the distortion of the signal, it is necessary to reduce the number of power corrections while controlling the power of the signal within the threshold power level. To this end, the power control must be properly performed with regard to proper objects.

### SUMMARY OF THE INVENTION

Accordingly, the present invention has been made to solve the above-mentioned problems occurring in the prior art, and an object of the present invention is to provide an apparatus and a method for reducing a peak-to-average power ratio (PAPR) of a forward link signal in a code division multiple access (CDMA) communication system.

Another object of the present invention is to provide an apparatus and a method capable of minimizing the distortion of a forward link signal in a multiple carrier CDMA communication system by properly determining a power control object.

Still another object of the present invention is to provide an apparatus and a method for reducing a PAPR of a forward link signal in a multiple carrier CDMA communication system, which can be embodied by properly determining a power control object and generating a correction waveform.

Still another object of the present invention is to provide an apparatus and a method capable of reducing a PAPR of an input signal through multiple steps.

In order to accomplish these objects, according to a first aspect of the present invention, there is provided an apparatus for reducing a peak-to-average power ratio of a transmission signal in a mobile communication system. The apparatus comprises a power control object determination unit for determining a power control object by detecting a peak signal having a highest power for a predetermined period of time from among input signals including a plurality of sub-peak signals; a power correction signal generation unit for outputting at least one correction waveform in order to correct an input signal determined to be the power control object; and a power correction unit for outputting a signal to which at least one correction waveform is applied.

In order to accomplish these objects, according to a second aspect of the present invention, there is provided a method for reducing a peak-to-average power ratio of a transmission signal in a mobile communication system. The method comprises the steps of: determining a peak signal as a power control object if the peak signal has a highest power for a predetermined period of time from among input signals including a plurality of sub-peak signals; outputting at least one correction waveform in order to correct a power of an input signal determined as the power control object; and outputting a signal by applying at least one correction waveform to the input signal.

### BRIEF DESCRIPTION OF THE DRAWINGS

The above and other objects, features and advantages of the present invention will be more apparent from the following detailed description taken in conjunction with the accompanying drawings, in which:

FIG. 1 is a view illustrating a forward link signal generator of a conventional code division multiple access (CDMA) communication system using multiple carriers;

FIG. 2 is a block view illustrating an internal structure of a peak-to-average power ratio (PAPR) reduction apparatus according to an embodiment of the present invention;

FIGS. 3A and 3B are graphs illustrating power waveforms of forward link signals in a CDMA communication system using multiple carriers;

FIG. 4 is a view illustrating a shift register provided in a power control object determination unit shown in FIG. 2;

FIGS. 5A and 5B are flowcharts illustrating a procedure of determining a power control object by means of a power control object determination unit according to an embodiment of the present invention;

FIG. 6 is a block view illustrating an internal structure of a correction waveform generator shown in FIG. 2;

FIG. 7 illustrates graphs showing waveforms obtained by combining outputs of correction waveform generators shown in FIG. 6; and

FIG. 8 is a flowchart illustrating a procedure of reducing a PAPR according to an embodiment of the present invention.

### DETAILED DESCRIPTION OF THE PREFERRED EMBODIMENT

Hereinafter, embodiments of the present invention will be described with reference to the accompanying drawings. In the following detailed description, the same reference numerals are used to refer the same elements. In addition, a detailed description of known functions and configurations incorporated herein will be omitted for conciseness.

The embodiment of the present invention provides an apparatus and a method for reducing a peak-to-average power ratio (PAPR) of a signal forming a random-type power waveform due to multiple carriers or multiple frequency assignment (FA) in a code division multiple access (CDMA) communication system, in which the apparatus and the method can determine an input signal to be power-controlled, thereby effectively controlling the peak power of the input signal by performing power correction with respect to the input signal while maintaining the quality of the input signal. In the following description, the term “power control object” signifies a sample of a predetermined input signal having power exceeding a predetermined threshold power and capable of minimizing the signal distortion thereof if it undergoes power correction. In addition, the term “sample” refers to the input signal, which is subject to power measurement for determining the power control object.

According to an embodiment of the present invention, when detecting peaks of signals for performing the power control with respect to the signals in a multiple carrier CDMA communication system, peaks of predetermined samples satisfying predetermined conditions are only detected by taking the power of peripheral samples into consideration, so an undesired power control operation is reduced, thereby minimizing the signal distortion. In addition, since one-step power correction may reduce the PAPR of the signal within a limited range, the embodiment of the present invention performs multi-step power correction, thereby effectively reducing the PAPR of the signal. Furthermore, the embodiment of the present invention provides a correction waveform generator capable of generating combined correction waveforms with regard to a plurality of input signal samples, instead of performing a filtering process in order to suppress spectral emission, so that the structure of the PAPR reduction apparatus can be simplified.

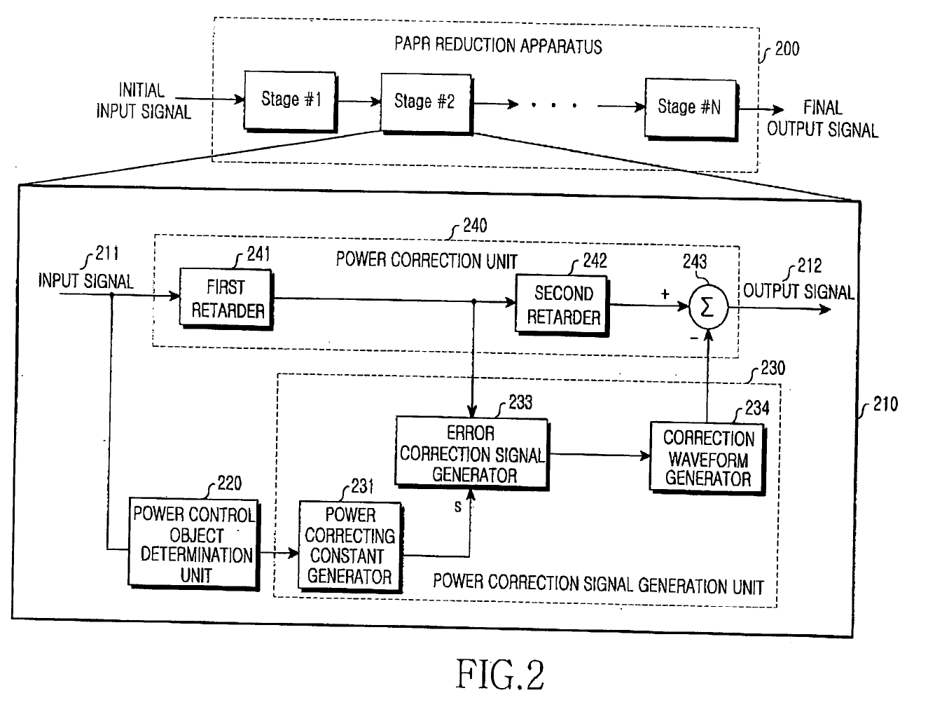

Hereinafter, an apparatus for reducing the PAPR according to an embodiment of the present invention will be described with reference to FIG. 2.

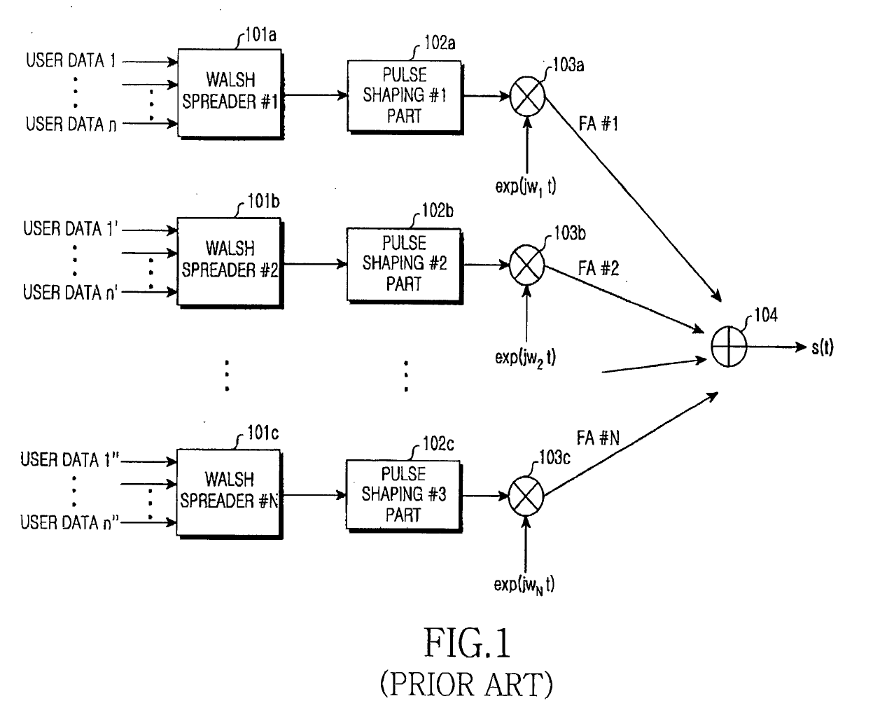

FIG. 2 is a block view illustrating an internal structure of a PAPR reduction apparatus 200 according to one embodiment of the present invention. The PAPR reduction apparatus 200 shown in FIG. 2 receives the output signal s(t) of the forward link signal generator shown in FIG. 1 as an initial input signal. As mentioned above, the output signal s(t) includes a plurality of FA signals. In addition, the PAPR reduction apparatus 200 reduces the PAPR of the input signal through multiple stages until a final output signal is output through the PAPR reduction apparatus 200. Each of the multiple stages may be performed with the same operational procedure by means of the same PAPR reduction apparatus 200. Hereinafter, a structure of the PAPR reduction apparatus 200 will be described in detail with reference to a block 210 shown in FIG. 2.

Referring to FIG. 2, an input signal 211 is an input signal of a present stage and an output signal of a previous stage, and an output signal 212 is an output signal of the present stage and an input signal of a next stage.

The block 210 includes a power control object determination unit 220 for determining the power control operation with respect to an input signal sample, a power correction signal generation unit 230 for generating a power correction signal in order to control power of the input signal 211 if the input signal 211 is determined as the power control object, and a power correction unit 240 for correcting the input signal 211 by using the power correction signal generated from the power correction signal generation unit 230 corresponding to each stage (stage #1˜stage #N) of the PAPR reduction apparatus 200.

The power control object determination unit 220 checks whether the power control operation must be performed with respect to the input signals, which are sequentially input, by taking fore and apt signal samples into consideration. At this time, it is important to prevent a repetition of an undesired power control by taking the power waveform of the input signal into consideration.

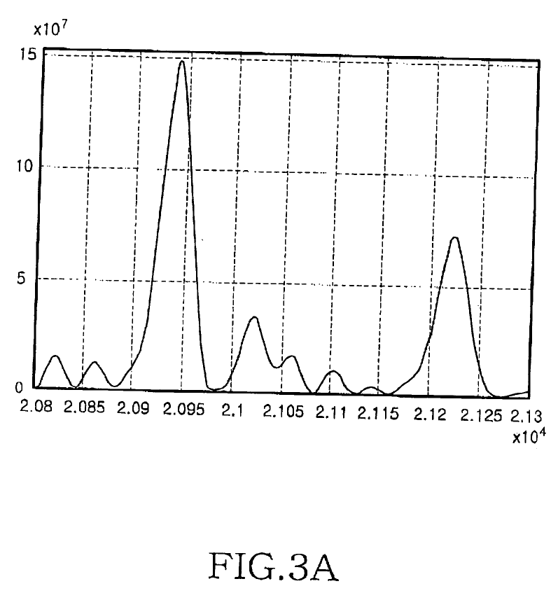

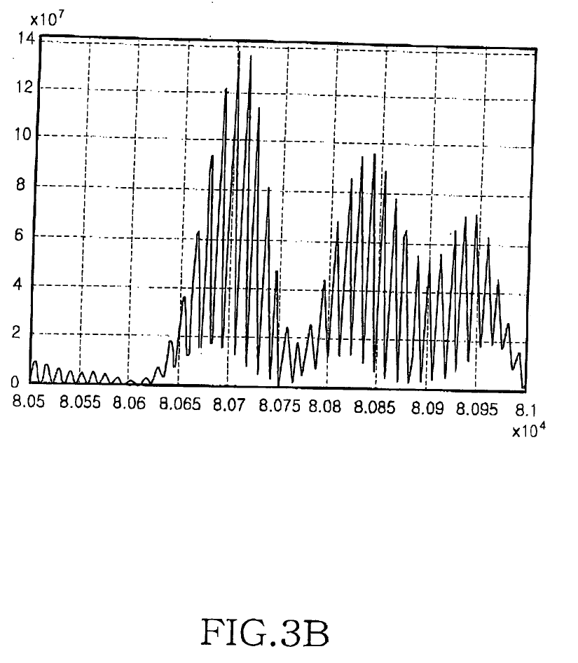

FIGS. 3A and 3B are graphs illustrating power waveforms of forward link signals in the CDMA communication system using multiple carriers. In addition, it should be noted that the number of carriers of the FA signal having the power waveform shown in FIG. 3A is different from that of the FA signal having the power waveform shown in FIG. 3B. In addition, FIGS. 3A and 3B show waveforms of signal samples, which are sampled during the same period of time.

Referring to FIG. 3A, variation of the power waveform is relatively small, so the sample is determined as the power control object if the sample has power greater than those of fore and apt samples and the predetermined threshold power. However, in a case of FIG. 3B, the power waveform of the signal represents the combination of a low frequency and a high frequency due to a characteristic of the frequency band. In this case, if the power control object determination scheme used for the power waveform shown in FIG. 3A is applied to the power waveform shown in FIG. 3B, undesired power control object signals are unnecessarily generated, so the distortion of the original signal becomes enlarged. In order to minimize the signal distortion, the power control operation for sub-peaks derived from the high frequency must be suppressed by performing a proper power control object determination scheme. In addition, since there is a great possibility that the power control for the predetermined sample cannot be properly conducted due to an overlap of power control signals, such a determination of the sub-peak may affect the performance of the PAPR reduction apparatus.

Accordingly, in a case of the power waveform shown in FIG. 3B, the power control object determination unit 220 determines the sub-peak having the highest power in a predetermined time interval as a power control object.

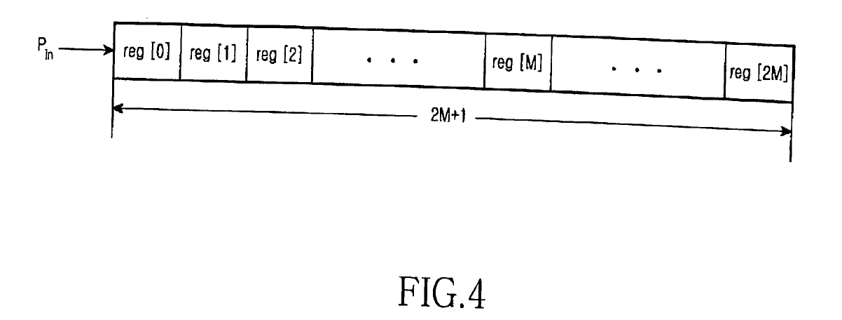

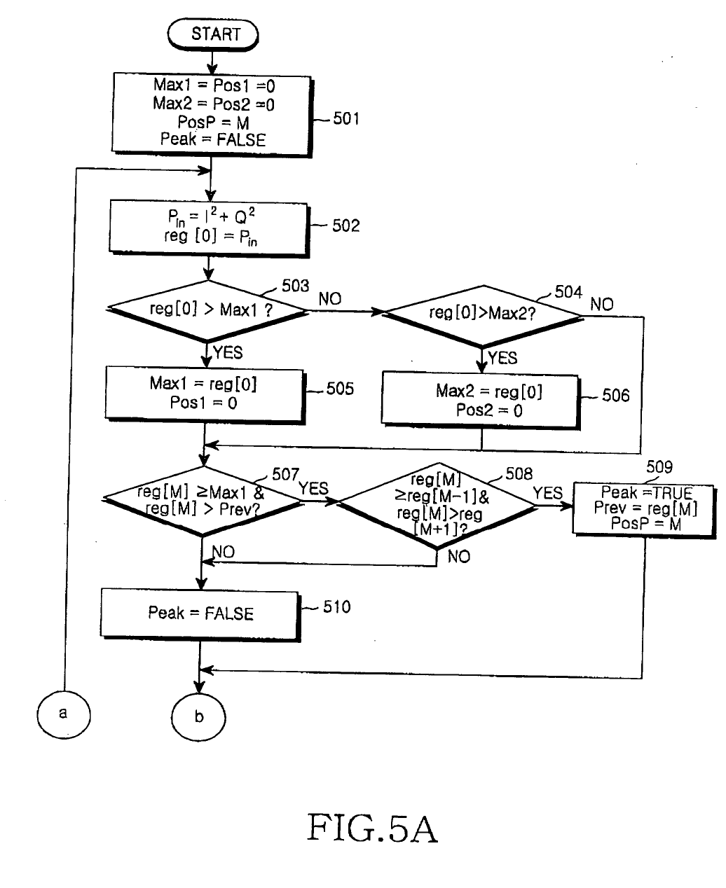

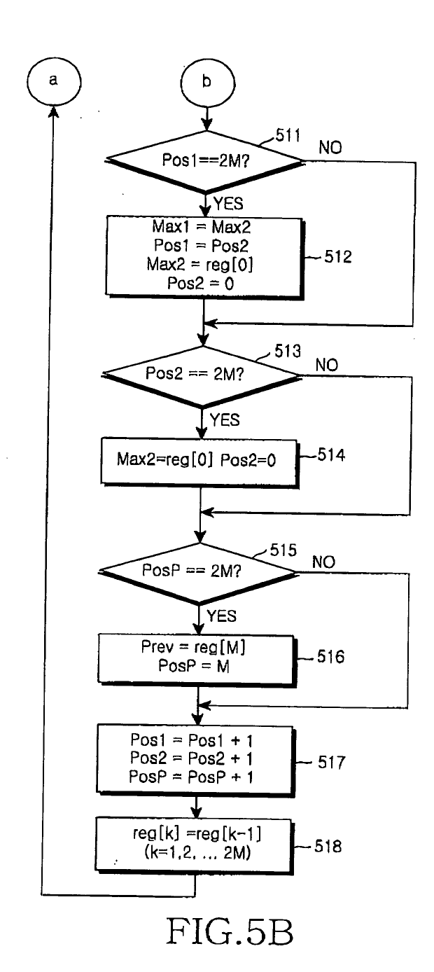

Hereinafter, an operation of the power control object determination unit 220 will be described in detail with reference to FIGS. 4, 5A and 5B.

FIG. 4 is a view illustrating a shift register provided in the power control object determination unit 220 shown in FIG. 2.

In order to determine the power control object, the power control object determination unit 220 includes a register or a buffer as shown in FIG. 4. Referring to FIG. 4, 2M+1 registers (reg[0]-reg[2M]) are provided in order to determine the power control object, wherein M is a value determined according to a waveform characteristic of a signal. Power values of signal samples, which are sequentially input, are stored in the registers. That is, a power value of a present input signal is stored in a register (reg[0]), and power values of previous signal samples are stored in registers (reg[1]-reg[2M]). In addition, as a power value of a new input signal is input into the register (reg[0]), the power values stored in the registers (reg[1]-reg[2M]) are sequentially shifted in a right direction one by one.

Hereinafter, the operation of the power control object determination unit 220 by using the register as shown in FIG. 4 will be described in detail with reference to FIGS. 5A and 5B.

FIGS. 5A and 5B are flowcharts illustrating a procedure of determining the power control object by means of the power control object determination unit according to one embodiment of the present invention.

Referring to FIG. 5A, the power control object determination unit 220 assigns initial values of parameters used for determining the initial power control object in step 501. The parameters used for determining the initial power control object and values assigned to the parameters are shown in Table 1.

TABLE 1

| Parameters | Values |
|---|---|
| Max1 | Highest power value from among power values stored in |
| | 2M + 1 registers |
| Pos1 | Position of register storing power value of Max1 |
| Max2 | Second-highest power value from among power values |
| | stored in 2M + 1 registers |
| Pos2 | Position of register storing power value of Max2 |
| Prev | Highest power value from among power values stored in |
| | reg[M] to reg[2M] |
| PosP | Position of register storing power value of Prev |
| Peak | Used for determining power control object for samples |
| | based on power value stored in reg[M], initial |
| | value thereof is regarded as non-power control object |

In Table 1, Pos1, Pos2 and PosP represent indexes for registers in a predetermined period. Herein, since Pos1, Pos2 and PosP represent the positions of the 2M+1 registers, reg[0] is set to 0, reg[1] is set to 1, and reg[2M] is set to 2M.

In step 502, the power control object determination unit 220 stores power (Pin) of the present input signal in reg[0] by calculating the power (Pin) according to following Equation 1:
Pin=I²+Q² Equation 1

In step 503, the power control object determination unit 220 compares the power value of reg[0] with the power value of Max1, which represents the highest power value from among power values stored in reg[1] to reg[2M]. If it is determined in step 503 that the power value of reg[0] is larger than the power value of Max1, the power control object determination unit 220 replaces the power value of the reg[0] with the power value of Max1 in step 505, and sets Pos1 representing the position of the register storing the power value of Max1 to 0. However, if it is determined in step 503 that the power value of reg[0] is smaller than the power value of Max1, the power control object determination unit 220 compares the power value of reg[0] with the power value of Max2, which represents the second-highest power value from among the power values stored in reg[1] to reg[2M] in step 504. If it is determined in step 504 that the power value of reg[0] is larger than the power value of Max2, the power control object determination unit 220 replaces the power value of the reg[0] with the power value of Max2, and sets Pos2 representing the position of the register storing the power value of Max2 to 0 in step 506. However, if it is determined in step 504 that the power value of reg[0] is smaller than the power value of Max2, step 507 is performed. According to the present embodiment, only the highest and second-highest power values compared with the power value of reg[0] are set as Max1 and Max2. However, according to another embodiment of the present invention, a plurality of power values can be compared with the power value of reg[0].

If the power value of reg[0] is identical to or smaller than the power values of the Max1 and Max2, the power control object determination unit 220 checks whether the power value of reg[M] is larger than the power value of Max1 and the power value of Prev, which represents the highest power value from among power values stored in reg[M] to reg[2M] in step 507. The power value of reg[M] is compared with the power value of Prev in step 507 because there is a possibility that the power value of the Max1 is not the highest power value. This will be described later in detail after explaining step 518 with reference to FIG. 5B.

If it is determined in step 507 that the power value of reg[M] is larger than the power value of Max1 and the power value of Prev, the power control object determination unit 220 checks whether the power value of reg[M] is larger than the power value of reg[M−1] and the power value of reg[M+1] in step 508. That is, according to an embodiment of the present invention, the power value of the input signal sample stored in reg[M] is compared with power values of adjacent samples to determine the power control object. If it is determined in step 508 that the power value of reg[M] is larger than the power value of reg[M−1] and the power value of reg[M+1], the power control object determination unit 220 determines that the input signal having the power value of reg[M] is a power control object requiring the power correction (Peak=true), so the power control object determination unit 220 replaces the power value of reg[M] with the power value of Prev and sets PosP to M in step 509. Otherwise, the power control object determination unit 220 determines in step 510 that the input signal having the power value of reg[M] is not the power control object (Peak=false). After that, the power control object determination unit 220 checks whether Pos1 representing the position of the register storing the power value of Max1 is set to 2M in step 511. If it is determined in step 511 that Pos1 is set to 2M, step 512 is performed. Otherwise, step 513 is performed.

That is, if it is determined in step 511 that Pos1 is set to 2M, the power control object determination unit 220 replaces the power value of Max2 with the power value of Max1 and replaces the position value of Pos2 representing the position of the register storing the power value of Max2 with the position value of Pos1. In addition, the power control object determination unit 220 temporarily sets the power value of Max2 as the power value of reg[0], and sets the position value of Pos2 to 0. In this case, it is also possible to set the power value of Max2 and the position values of the Pos2 to 0. That is, if the position of the signal having the highest power value in the 2M+1 registers is shifted beyond a predetermined range of the 2M+1 registers, there is no comparison object for the new input sample. For this reason, the power value of Max2 is replaced with the power value of Max1.

However, if it is determined in step 511 that Pos1 is not 2M, step 513 is performed. In step 513, the power control object determination unit 220 checks whether the Pos2 is 2M. If it is determined in step 513 that Pos2 is set to 2M, the power control object determination unit 220 temporarily sets the power value of Max2 as the power value of reg[0], and sets the position value of Pos2 to 0 in step 514. In this case, it is also possible to set the power value of Max2 and the position values of the Pos2 to 0.

However, if it is determined in step 513 that Pos2 is not 2M, step 515 is performed. In step 515, the power control object determination unit 220 checks whether the PosP is 2M. If it is determined in step 515 that PosP is set to 2M, the power control object determination unit 220 replaces the power value of reg[M] with the power value of Prev representing the highest power value from among power values stored in reg[M] to reg[2M] and sets the position value of PosP to M in step 516. That is, if the position of the signal having the highest power value from among power values stored in reg[M] to reg[2M] is shifted beyond a predetermined comparison range, the comparison object is disappeared. For this reason, the value of Prev is temporarily set as the value of reg[M].

However, if it is determined in step 515 that PosP is not 2M, step 517 is performed. In step 517, the power control object determination unit 220 increases the position values of Pos1, Pos2 and PosP by 1, respectively, thereby setting new position values for Pos1, Pos2 and PosP. Then, in step 518, power values stored in reg[0] to reg[2M−1] are shifted in a right direction by one field, thereby allowing the power value of the new input signal to be stored in reg[0]. When the shift of the power values has been conducted, reg[0] temporarily has no power value or has an invalid power value therein. In this state, step 502 is again performed in order to store the power value Pin of the new input signal sample in reg[0].

Hereinafter, the reason for setting Prev representing the highest power value from among power values stored in reg[M] to reg[2M] as a comparison object of reg[M] for determining the power control object in step 507 will be described.

For instance, when the position value of Pos1 representing the position of Max1 is 2M−1, and the position value of Pos2 representing the position of Max2 is 2M, the position of Max2 obviates from a range of 2M due to the shift operation performed in step 517, so 0 is stored for Max2 in step 514. In addition, Pos1 representing the position of Max1 is shifted into 2M. Then, the procedure returns to step 502 so as to receive the new input signal. Herein, if the power value of the new input signal is very small but larger than 0, it is determined that the new input signal has a value lower than that of Max1 in step 503. In addition, since the present Max2 is 0 in step 504, the value of the new input signal is stored as the value of Max2. After that, since Pos1 representing the position of Max1 is set to 2M in step 511, the value of Max1 is replaced with the value of Max2. In this case, although the power value, which is significantly larger than that of the new input signal, has been stored in registers, the very small value is stored for Max1, causing an error when determining the peak signal. In order to prevent such an error, according to an embodiment of the present invention, the highest power signal between M and 2M of the registers is separately stored so as to compare it with the reg[M].

Referring again to FIG. 2, the power correction signal generation unit 230 includes a power correction constant generator 231 capable of calculating and outputting a predetermined power correction constant s with regard to the input signal, which is determined as the power control object by the power control object determination unit 220, an error correction signal generator 233 for outputting a predetermined error correction signal by multiplying the power correction constant s output from the power correction constant generator 231 by an original signal, which is output while being delayed for a predetermined period of time by means of a first retarder 241, and a correction waveform generator 234, which receives the error correction signal from the error correction signal generator 233 and outputs a predetermined power correction signal having a predetermined correction waveform (hereinafter, referred to as “correction waveform generation coefficient”) and corresponding to a frequency band of the input signal.

If a predetermined input signal is determined as a power control object by means of the power control object determination unit 220, the power correction constant generator 231 calculates and outputs the predetermined power correction constant s corresponding to the power control object according to the following Equation 2:

$$\begin{matrix}P < {P}_{TH} ; s = 0 \\ P > {P}_{TH} ; S = 1 - \sqrt{\frac{{P}_{TH}}{P}}\end{matrix} \qquad Equation 2$$

In Equation 2, P refers to the power of the power control object determined by the power control object determination unit 220, and P_{TH} refers to the predetermined threshold power. That is, signals having power levels above PTH are subject to the power control operation. In Equation 2, the power correction constant s has a value between 0 and 1, which indicates a ratio of power to be clipped in relation to the power P of the power control object. In addition, if the power control object determination unit 220 determines that the input signal samples are not the power control objects, the power correction constant generator 231 sets the power correction constant s of the input signal samples to 0 in the same manner as the input signal samples having power levels less than P_{TH}.

The error correction signal generator 233 outputs the predetermined error correction signal by multiplying the power correction constant s output from the power correction constant generator 231 by the original signal, which is delayed for a predetermined period of time by means of the first retarder 241. That is, the error correction signal can be obtained by multiplying each sample of the original signal, which is output while being delayed for a predetermined period of time, by a power ratio of the power control signal to be clipped. The error correction signal output from the error correction signal generator 233 is introduced into the correction waveform generator 234. Herein, the error correction signal has a value of “0” with respect to the samples having power levels lower than the threshold power or with respect to samples which are regarded as non-power control objects by the power control object determination unit 220 even if they have power greater than the threshold power. In addition, the error correction signal has a predetermined value, other than “0”, with respect to the samples corresponding to the power control objects having power exceeding the threshold power. Such an error correction signal having the predetermined value is referred to as an error correction signal peak or an error peak signal.

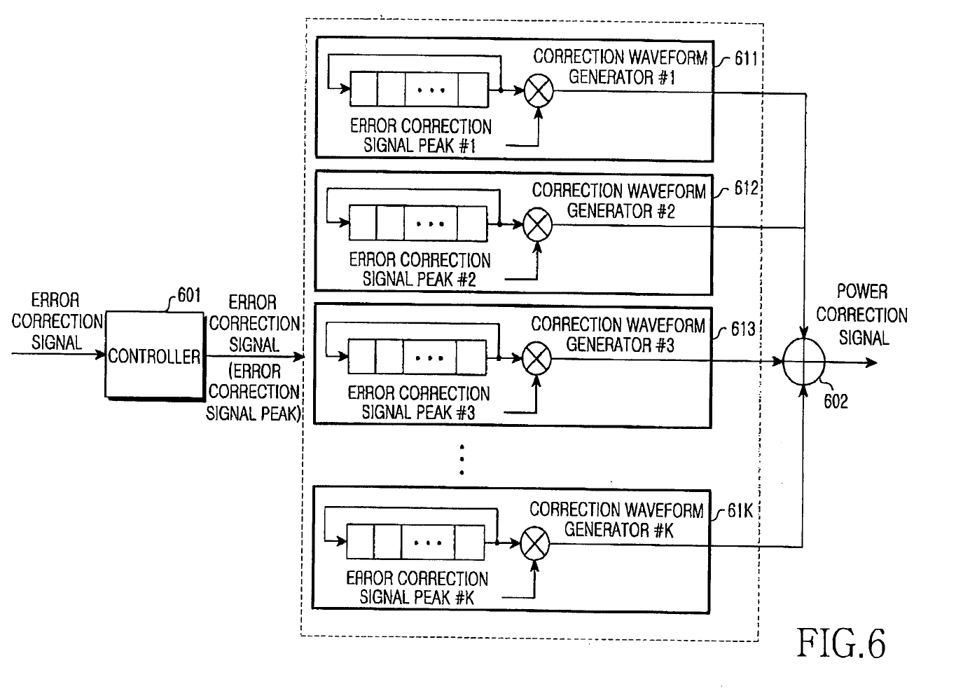

The correction waveform generator 234 may generate the power correction signal corresponding to the output of the power correction constant generator 231. Hereinafter, an internal structure of the correction waveform generator 234 will be described with reference to FIG. 6.

FIG. 6 is a block view illustrating the internal structure of the correction waveform generator 234 shown in FIG. 2.

Referring to FIG. 6, a controller 601 receives error correction signal samples from the error correction signal generator 233 and outputs the samples having values of “0” as power correction signals. However, if error correction signal peaks having predetermined values, other than “0”, are input into the controller 601, the controller 601 checks whether there are currently available correction waveform generators from among correction waveform generators 611 to 61K. If it is determined that there are no currently available correction waveform generators, the error signal peak is disregarded. However, if there are currently available correction waveform generators, the error correction signal peak is input into the corresponding correction waveform generator.

The correction waveform generator outputs the predetermined correction waveform by multiplying the correction waveform generation coefficient by the error correction signal peak. In FIG. 6, the correction waveform generation coefficient is in the form of the shift register and is multiplied by the error correction signal peak.

As shown in FIG. 6, the power correction signal, which is a final output signal of the correction waveform generator 234, is the sum of the correction waveforms output from the correction waveform generators 611 to 61K. If K correction waveform generators are provided, K power correction constants s, which are different from each other, are utilized so as to generate correction waveforms in relation to K error correction signal peaks, which are different from each other. However, it should be noted that the plurality of error correction signals output from the controller 601 do not mean that the plurality of error correction signals are simultaneously output from the controller 601 with regard to a single input signal, but indicate that the plurality of error correction signals are sequentially input into the available correction waveform generators or sequentially output without being input into the available correction waveform generators. That is, when one correction waveform generator starts to generate the correction waveform in relation to the present power correction constant s, it is impossible to generate the correction waveform in relation to other power correction constant s during a time interval L of the correction waveform generation coefficient. Accordingly, if the error correction signal peak having the predetermined value, other than “0”, is input while all of available correction waveform generators are being operated, the correction waveform with regard to the error correction signal peak cannot be generated, so that the error correction signal peak is disregarded. Therefore, in order to reduce the number of error correction signal peaks which are disregarded, it is necessary to properly determine the number of correction waveform generators by taking the characteristics of the power waveform of the input signal into consideration. In addition, the disregarded error correction signal peaks can be detected again in the next stage while repeating the multiple-step scheme of the present invention.

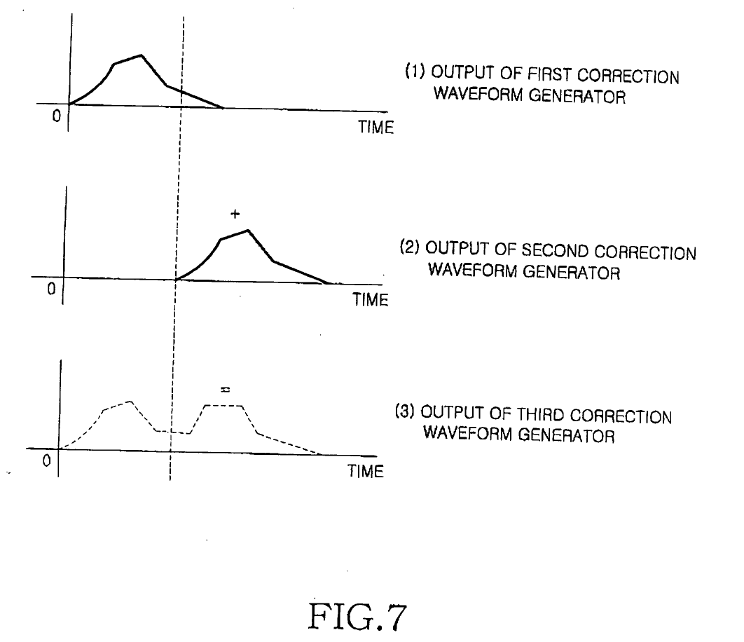

Accordingly, the first correction waveform generator 611 generates the correction waveform with respect to the first error correction signal peak, and the second correction waveform generator 611 generates the correction waveform with respect to the second error correction signal peak. In addition, the K^{th} correction waveform generator 61K generates the correction waveform with respect to the K^{th} error correction signal peak. Since the error correction signal peaks are input into the correction waveform generators with predetermined time intervals, the correction waveforms are output from the waveform generators 611 to 61K with predetermined time intervals. In the meantime, the correction waveforms are input into an adder 602. The adder 602 sequentially combines and outputs the correction waveforms as shown in FIG. 7.

Herein, the adder 602 shown in FIG. 6 primarily combines the correction waveform signals output from the correction waveform generators. Then, the adder 602 adds/subtracts the correction waveform signals to/from the delayed original signal in the adder 243 shown in FIG. 2. This procedure is the same as the procedure of the adder 243 which adds/subtracts the correction waveform signals of the correction waveform generators to/from the delayed original signal. Preferably, the correction waveform is generated in such a manner that the power of the input signal can be reduced by a difference between the power of the input signal and the threshold power.

Referring again to FIG. 2, the power correction unit 240 includes the first retarder 241 for outputting the input signal 211 while delaying the input signal 211 for a predetermined period of time, the second retarder 242, and the adder 243. The adder 243 adds/subtracts the power correction signal output from the power correction signal generation unit 230 to/from the original signal output from the second retarder 242, thereby adjusting the power of the output signal such that the output signal has the power lower than the threshold power. The number of the retarders 241 and 242 can be properly adjusted. In addition, the adder 243 may add/subtract the power correction signal to/from the original signal based on the correction waveform generation coefficient used in the correction waveform generator 234.

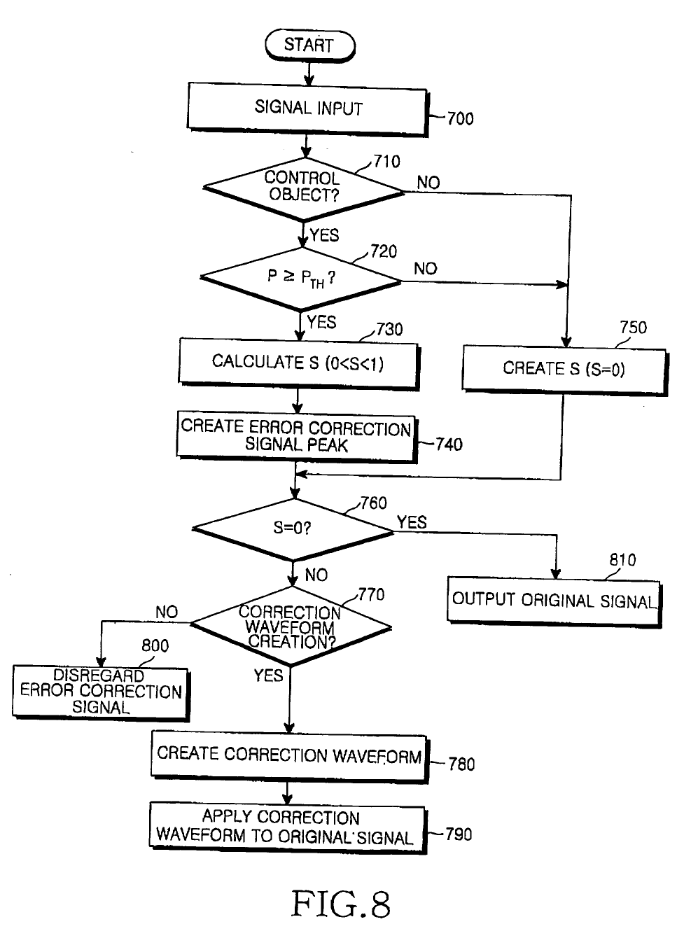

Hereinafter, the method for reducing the PAPR of the signal by using the PAPR reduction apparatus according to an embodiment of the present invention will be described with reference to the flowchart shown in FIG. 8.

When the signal is input in step 700, the power control object determination unit 220 checks whether the signal is the power control object having the highest power in predetermined fore and apt periods. The power control object determination unit 220 may determine the peak signal as the power control object if the peak signal has the highest power in the predetermined periods even if the peak signal has the waveform as shown in FIG. 3B. The operation of the power control object determination unit 220 has been previously described with reference to FIGS. 5A and 5B, so it will not be described further.

If it is determined in step 710 that the input signal is the power control object having the highest power in the predetermined periods, the power correction signal generation unit 230 checks whether the power of the power control object is identical to or larger than the threshold power PTH in step 720. If it is determined in step 720 that the power control object is identical to or larger than the threshold power PTH, the power correction signal generation unit 230 calculates the power correction constant s (0<s<1) with respect to the power control object in step 730 and creates the error correction signal peak by multiplying the power correction constant s by the original signal in step 740. Then, step 760 is performed.

However, if it is determined in step 710 that the input signal is not the power control object or if it is determined in step 720 that the power control object is smaller than the threshold power PTH, the power correction signal generation unit 230 sets the power correction constant s to “0” in step 750. Then, step 760 is conducted.

In step 760, the power correction signal generation unit 230 checks whether the power correction constant s is “0”. If it is determined in step 760 that the power correction constant s is not “0”, the power correction signal generation unit 230 checks whether it is possible to generate the correction waveform of the error correction signal in step 770. That is, the power correction signal generation unit 230 checks whether all of the correction waveform generators shown in FIG. 6 are being operated. If it is determined in step 770 that it is possible to generate the correction waveform with respect to the present error correction signal, the power correction signal generation unit 230 receives the error correction signal peak and generates the power correction signal corresponding to the predetermined waveform adaptable for the signal band in step 780. In addition, the power correction unit 240 adds/subtracts the power correction signal to/from the original signal, which is delayed for a predetermined period of time, thereby generating the corrected signal in step 790. The original signal can be obtained by delaying the input signal for a predetermined period of time.

If it is determined in step 770 that it is impossible to generate the correction waveform with respect to the present error correction signal, the power correction signal generation unit 230 disregards the error signal peak in step 800. In addition, if it is determined in step 760 that the power correction constant s is set to “0”, the power correction signal generation unit 230 does not generate the waveform. Thus, the power correction unit 240 outputs the original signal in step 810.

As described above, according to an embodiment of the present invention, the PAPR of the signal can be effectively reduced by properly determining the power control object in the CDMA communication system using the multiple carriers. In addition, the embodiment of the present invention provides the correction waveform generator, instead of performing the filtering process in order to suppress spectral emission derived from clipping during the power correction, so that the structure of the PAPR reduction apparatus can be simplified. Furthermore, since the PAPR can be reduced through multiple stages, it is possible to precisely detect the power control object, thereby significantly reducing the PAPR of the signal. In addition, the spectrum of the signal, which undergoes the power correction according to an embodiment of the present invention, is rarely distorted so that quality of the signal can be effectively preserved without being damaged.

While the invention has been shown and described with reference to a certain embodiment thereof, it should be understood by those skilled in the art that various changes in form and details may be made therein without departing from the spirit and scope of the invention as defined by the appended claims.

1. An apparatus for reducing a peak-to-average power ratio of a transmission signal in a mobile communication system, the apparatus comprising:
a power control object determination unit for determining a power control object by detecting a peak signal having a highest power for a predetermined period of time from among input signals including a plurality of sub-peak signals;
a power correction signal generation unit for outputting at least one correction waveform in order to correct an input signal determined to be the power control object; and
a power correction unit for outputting a signal by applying at least one correction waveform to the input signal.

2. The apparatus as claimed in claim 1, wherein the power correction signal generation unit includes a power correction constant generator capable of calculating and outputting a predetermined power correction constant which is a power correction ratio with regard to the input signal determined as the power control object by the power control object determination unit, an error correction signal generator for outputting a predetermined error correction signal by multiplying the power correction constant output from the power correction constant generator by an original input signal, and a correction waveform generating section, which receives the error correction signal from the error correction signal generator and outputs a predetermined power correction signal having at least one correction waveform and corresponding to a frequency band of the input signal.

3. The apparatus as claimed in claim 2, wherein the power correction constant generator outputs the power correction constant by calculating a clipping ratio with respect to the input signal if the input signal is determined as the power control object by the power control object determination unit and the power of the input signal exceeds the threshold power.

4. The apparatus as claimed in claim 2, wherein the power correction constant is calculated according to a following equation:
$$S = 1 - \sqrt{\frac{{P}_{TH}}{P}}$$
wherein, S is the power correction constant, P_{TH} is the threshold power, and P is the power of input signal.

5. The apparatus as claimed in claim 2, wherein the power correction constant generator sets the power correction constant to 0 with respect to the input signal if the input signal is determined to be a non-power control object by means of the power control object determination unit.

6. The apparatus as claimed in claim 2, wherein the correction waveform generating section includes at least one correction waveform generator capable of generating at least one correction waveform by multiplying a predetermined correction waveform generation coefficient adaptable for a frequency band of the input signal by the error correction signal, a controller for assigning the error correction signal to at least one correction waveform generator, and an adder for outputting the power correction signal by combining the correction waveforms generated from at least one correction waveform generator.

7. The apparatus as claimed in claim 6, wherein the controller allocates the correction waveform generator so as to generate the correction waveform when the power correction constant is not 0.

8. The apparatus as claimed in claim 7, wherein the controller does not allocate the correction waveform generator if there is no currently available correction waveform generator after checking the correction waveform generators.

9. The apparatus as claimed in claim 6, wherein the correction waveform generator stores the predetermined correction waveform generation coefficient, which is multiplied by the error correction signal, in an internal shift register.

10. The apparatus as claimed in claim 1, wherein the power correction unit includes at least one retarder for delaying the input signal for a predetermined period of time.

11. The apparatus as claimed in claim 1, wherein the power control object determination unit sequentially stores power values of sampled input signals in 0^{th} to 2M^{th} registers, and determines the input signal corresponding to the power value stored in the M^{th} register as the power control object if the power value stored in the M^{th} register is identical to or larger than a maximum power value, larger than a highest power value selected from power values stored in M^{th} to 2M^{th} registers, and larger than a power value stored in an adjacent register.

12. The apparatus as claimed in claim 1, wherein at least one correction waveform has a correction power corresponding to a difference between a power of the input signal determined to be the power control object and a predetermined threshold power.

13. A method for reducing a peak-to-average power ratio of a transmission signal in a mobile communication system, the method comprising the steps of:
i) determining a peak signal as a power control object if the peak signal has a highest power for a predetermined period of time from among input signals including a plurality of sub-peak signals;
ii) outputting at least one correction waveform in order to correct a power of an input signal determined as the power control object; and
iii) outputting a signal by applying at least one correction waveform to the input signal.

14. The method as claimed in claim 13, wherein step i) includes the substeps of calculating a predetermined power correction constant which is a power correction ratio with regard to the input signal determined as the power control object, outputting a predetermined error correction signal by multiplying the power correction constant by an original input signal, and receiving the error correction signal and outputting a predetermined power correction signal having at least one correction waveform and corresponding to a frequency band of the input signal.

15. The method as claimed in claim 14, wherein the power correction constant is output by calculating a clipping ratio with respect to the input signal, if the input signal is determined to be the power control object and the power of the input signal exceeds the threshold power.

16. The method as claimed in claim 14, wherein the power correction constant is calculated according to a following equation:
$$S = 1 - \sqrt{\frac{{P}_{TH}}{P}}$$
wherein, S is the power correction constant, P_{TH} is the threshold power, and P is the power of input signal.

17. The method as claimed in claim 15, wherein the power correction constant is set to be 0 with respect to the input signal if the input signal is determined to be a non-power control object.

18. The method as claimed in claim 14, wherein the substep of generating the predetermined power correction signal includes the steps of allocating the error correction signal to at least one correction waveform generator, generating at least one correction waveform by multiplying a predetermined correction waveform generation coefficient adaptable for a frequency band of the input signal by the error correction signal, and outputting the power correction signal by combining the correction waveforms generated from at least one correction waveform generator.

19. The method as claimed in claim 13, wherein the input signal is added/subtracted to/from the correction waveform after the input signal has been delayed for a predetermined period of time.

20. The method as claimed in claim 13, wherein step i) includes the substeps of sequentially storing power values of sampled input signals in 0^{th} to 2M^{th} registers, checking whether a power value of a predetermined input signal stored in the M^{th} register satisfies a first condition defined by an Equation 1, checking whether the power value of the predetermined input signal stored in the M^{th} register satisfies a second condition defined by an Equation 2, and determining the input signal corresponding to the power value stored in the M^{th} register as the power control object if the power value stored in the M^{th} register satisfies the first and second conditions wherein Equation 1 comprises reg[M]≧Max1 & reg[M]>Prev and Equation 2 comprises reg[M]≧reg[M−1] & reg[M]>reg[M+1], wherein parameters shown in Equations 1 and 2 are defined according to the following Table:

| Parameters | Values |
|---|---|
| Max1 | Highest power value from among power values stored in |
| | 2M + 1 registers |
| Prev | Highest power value from among power values stored in |
| | reg[M] to reg[2M] |
| Reg[M] | Power value of predetermined input signal stored in M^{th} |
| | register |

21. The method as claimed in claim 12, wherein the correction waveform is generated in such a manner that power of the input signal is reduced by a difference between the power of the input signal and the threshold power.
